(19) United States
(12) Patent Application Publication
(10) Pub. No.: US 2018/0039714 A1
(43) Pub. Date: Feb. 8, 2018

(54) LANDSCAPE DESIGN SYSTEMS AND METHODS

(71) Applicant: Wal-Mart Stores, Inc., Bentonville, AR (US)

(72) Inventors: Donald R. High, Noel, MO (US); John Paul Thompson, Bentonville, AR (US); David Winkle, Bella Vista, AR (US); Michael Dean Atchley, Springdale, AR (US)

(21) Appl. No.: 15/667,020

(22) Filed: Aug. 2, 2017

Related U.S. Application Data
(60) Provisional application No. 62/371,420, filed on Aug. 5, 2016.

(51) Int. Cl. G06F 17/50; G06K 9/00

(52) U.S. Cl. CPC G06F 17/5004; G06K 9/0063; G06F 17/5009

(57) ABSTRACT

A landscape design system comprises a first processor for retrieving a two-dimensional image of a real property in response to a query by a user of the landscape design system; a second processor that generates for display a two-dimensional view of a region of the real property for simulation; a converter that converts a region of the two-dimensional view into a three-dimensional image in response to an identification of the region of the real property; and a simulator that displays the three-dimensional image of the real property modified according to possible improvements to the real property.

### CROSS-REFERENCE TO RELATED APPLICATIONS

This invention claims priority to U.S. provisional patent application Ser. No. 62/371,420, filed Aug. 5, 2016 entitled “Landscape Design Systems and Methods”, the content of which is incorporated entirely herein by reference.

### FIELD

The present concepts relate generally to landscape design at garden centers, and more specifically, to systems and methods for assisting store customers with designing a landscape or garden architecture.

### BACKGROUND

Stores offering garden centers or the like typically receive customers during the planting season, or during other times of the year, for the purpose of improving their lawns, gardens, or other outdoor regions of their real property. Many of these customers are inexperienced, and seek assistance to perform their landscape-related improvements.

### BRIEF SUMMARY

In one aspect, landscape design system comprises a first processor for retrieving a two-dimensional image of a real property in response to a query by a user of the landscape design system; a second processor that generates for display a two-dimensional view of a region of the real property for simulation; a converter that converts a region of the two-dimensional view into a three-dimensional image in response to an identification of the region of the real property; and a simulator that displays the three-dimensional image of the real property modified according to possible improvements to the real property.

In some embodiments, the system further comprises a notification generator that generates and outputs alerts to an electronic device of the user regarding the simulated modified property.

In some embodiments, the first processor outputs a query to a remote database to receive the two-dimensional view of the property in response to a receipt by the processor of an address of the property.

In some embodiments, the two-dimensional view of the real property includes a satellite image.

In some embodiments, the system further comprises a third processor for retrieving data from a remote database that is used for generating simulation images that are part of a simulation of the three-dimensional image of the user's property.

In some embodiments, the system further comprises a recommendation engine that generates a recommendation for output to an electronic device.

In some embodiments, the recommendation includes information regarding purchased made regarding the recommended improvements to the user's property.

In some embodiments, the real property includes a property of the user of the landscape design system.

In some embodiments, the system further comprises a user interface for providing interactive access for the user to modify the three-dimensional image of the real property.

In some embodiments, the three-dimensional image is derived exclusively from the two-dimensional view of the real property.

In some embodiments, the three-dimensional image is derived from a combination of the two-dimensional view of the real property and user input.

In another aspect, a kiosk for landscape design comprises a first input device that receives a satellite image of a real property; a second input device that receives user input; a display for displaying the satellite image; and a modification processor for permitting a user at one or more of the second user input and the display to simulation of a region identified in the satellite region, the simulation including a landscape modification, the display further for displaying a representation of the identified region and a result of a recommendation for the landscape modification.

In some embodiments, the representation of the identified region includes three-dimensional image derived from a combination of the satellite image of the real property and the user input.

In some embodiments, the three-dimensional image is derived exclusively from a two-dimensional view of the satellite image of the real property.

In another aspect, a system for landscape design comprises a kiosk, comprising: an input device for receiving user inputs regarding a land property of a user; and a network device for communicating with a central computer. The central computer comprises a first processor for retrieving a two-dimensional image of a property of the land property in response to a query by the user at the kiosk; a second processor that generates for display a two-dimensional view of a region of the land property for simulation; a converter that converts a region of the two-dimensional view into a three-dimensional image in response to an identification of the region of the land property; and a simulator that displays the three-dimensional image of the land property modified according to recommended improvements to the land property.

In some embodiments, the system further comprises a 3-D printer for producing a physical representation of the modified three-dimension image.

In some embodiments, the kiosk displays a time of day bar, which identifies a location of the sun and an amount of shade at the selected region of the land property at a time of day, and wherein the recommended improvements take into account the location of the sun and an amount of shade at the selected region of the land property at the selected time of day.

In other aspect, a method for landscape design comprising receiving and processing by a special purpose hardware processor an electronic image of a real property; identifying regions of the property of interest where a user desires to perform a landscape project; and determining by a special purpose hardware processor recommendations to the regions of the property of interest.

In some embodiments, the method further comprises generating an alert regarding the recommendations.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram illustrating an environment at which embodiments of the present inventive concepts may be practiced.

FIG. 2 is a block diagram of a kiosk, in accordance with some embodiments.

FIG. 3 is a block diagram of a landscape planning processor, in accordance with some embodiments.

FIG. 4 is an illustration of flow paths between elements of the environment of FIG. 1, in accordance with some embodiment.

FIG. 5 is a flow diagram illustrating a landscape design process, in accordance with some embodiments.

FIG. 6A is a screenshot of a 2 dimensional satellite image.

FIG. 6B is a 3 dimensional representation of the 2-D satellite image of FIG. 6A, in accordance with some embodiments.

FIG. 6C is a 3 dimensional representation of the 2-D satellite image of FIG. 6A overlaid with a simulation produced according to a recommendation generated by a landscape planning processor, in accordance with some embodiments.

### DETAILED DESCRIPTION

In the following description, specific details are set forth although it should be appreciated by one of ordinary skill in the art that the systems and methods can be practiced without at least some of the details. In some instances, known features or processes are not described in detail so as to not obscure the present invention.

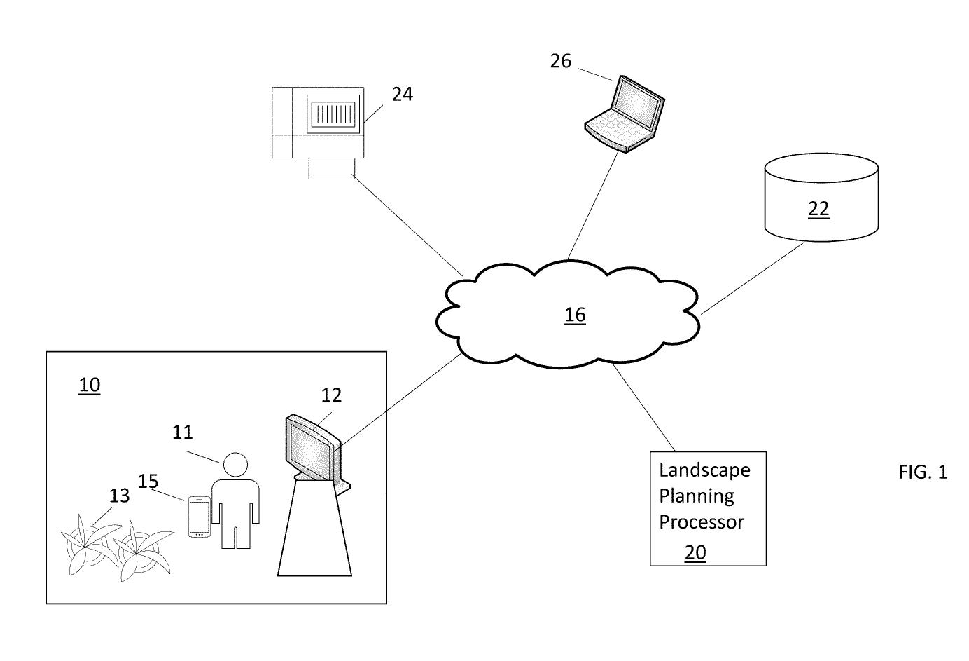

FIG. 1 is a diagram illustrating an environment at which embodiments of the present inventive concepts may be practiced.

A store customer 11 may be present in a garden center or other landscape-related store 10, where garden-related items 13 are offered. At the store 10, a kiosk 12 may be available for use by the customer 11, or other user of the kiosk 12. In some embodiments, the kiosk 12 is located at another public location such as a mall, airport, and so on.

A landscape design system may include other electronic components that communicate with the kiosk 12 and a user computer 14 such as a smartphone, notebook computer, and so on in possession by the customer 11. As shown in FIG. 1, other electronic components may include but not be limited to a landscape planning processor 20, data repository 22, and 3-D printer 24, which may communicate with each other and/or other electronic devices via network 16. The network 16 may be a public switched telephone network (PSTN), a mobile communications network, a data network, such as a local area network (LAN) or wide area network (WAN), or a combination thereof, or other communication network known to those of ordinary skill in the art.

The landscape planning processor 20 processes inputs for generating landscape or garden design recommendation. For example, the landscape planning processor 20 may process a 2-dimensional (2-D) satellite image of a customer's property, which may include relevant details such as the customer's home, property fence, existing garden, shrubbery, walkways, and so on, and convert relevant portions of the satellite image into a 3-dimensional (3-D) representation, or model, of the property, or at least a portion identified as being of interest by the user 11. In particular, 2-D data gathered from a satellite may be converted using a special-purpose processor into a 3-D image. The landscape planning processor 20 may generate recommended improvements to the selected region of the property based on user inputs, such as flower preferences, garden tools of interest, projects, and so on.

The data repository 22 may be a database or the like located remotely from the store 10 and accessible by the kiosk 12, landscape planning processor 20, and/or other electronic device used by the user 11. The data repository 22 may store information regarding real properties, such as maps, deeds, satellite images, and/or other information regarding a property of interest, which may be a candidate for landscape modifications. This information may be used by the landscape planning processor 20 to generate a 3-D representation of a user's property.

A remote computer 26 may be used to view or otherwise access simulation results, 3-D models, and so on produced by the landscape planning processor 20. Therefore, some or all features provided by the kiosk 12 may likewise be performed at the remote computer 26.

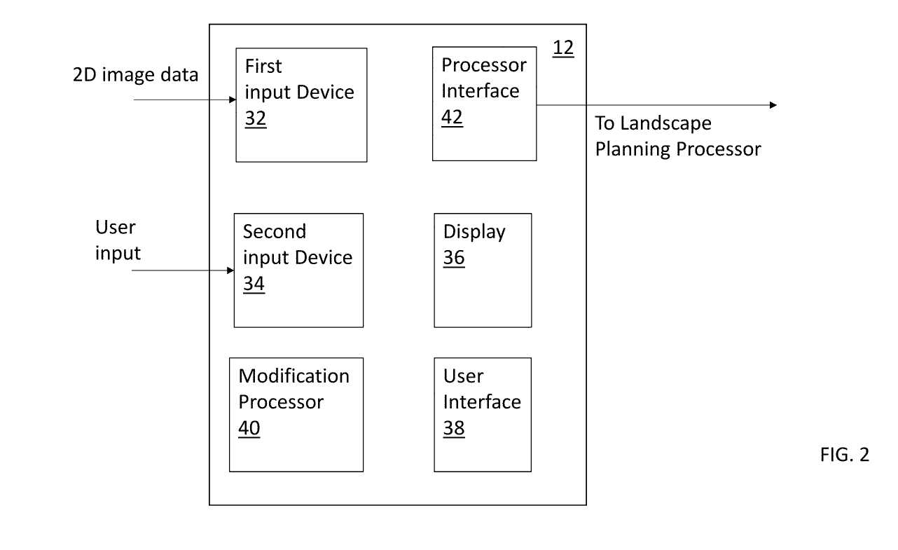

FIG. 2 is a block diagram of a kiosk 12, in accordance with some embodiments. The kiosk 12 may be part of the environment illustrated in FIG. 1.

The kiosk 12 includes a first input device 32, a second input device 34, a display 36, a user interface 38, a modification processor 40, and a processor interface 42. Some or all of these elements are stored in an electronic memory device and executed by a hardware processor of the kiosk 12. Some or all of these elements include hardware processors for performing functions of the elements. In some embodiments, at least some of these elements are performed on other electronic devices instead of the kiosk 12, which are in communication with the kiosk 12, for example, via the network 16.

The first input device 32 and the second input device 34 may include the same inputs or different inputs. For example, the first input device 32 and the second input device 34 may include a common physical connector to a network device for communicating with the network 16.

The first input device 32 is constructed and arranged to receive 2 dimensional data from the landscape planning processor 20, or directly from a data repository 22 or other information source, for example, which stores a satellite image of real property, also referred to as a land property, real estate, and so on.

The second input device 34 may include a touchscreen, mouse, keyboard, and so on for providing user input such as address information, specific requests, information in response to a displayed inquiry displayed by the user interface 38, and so on.

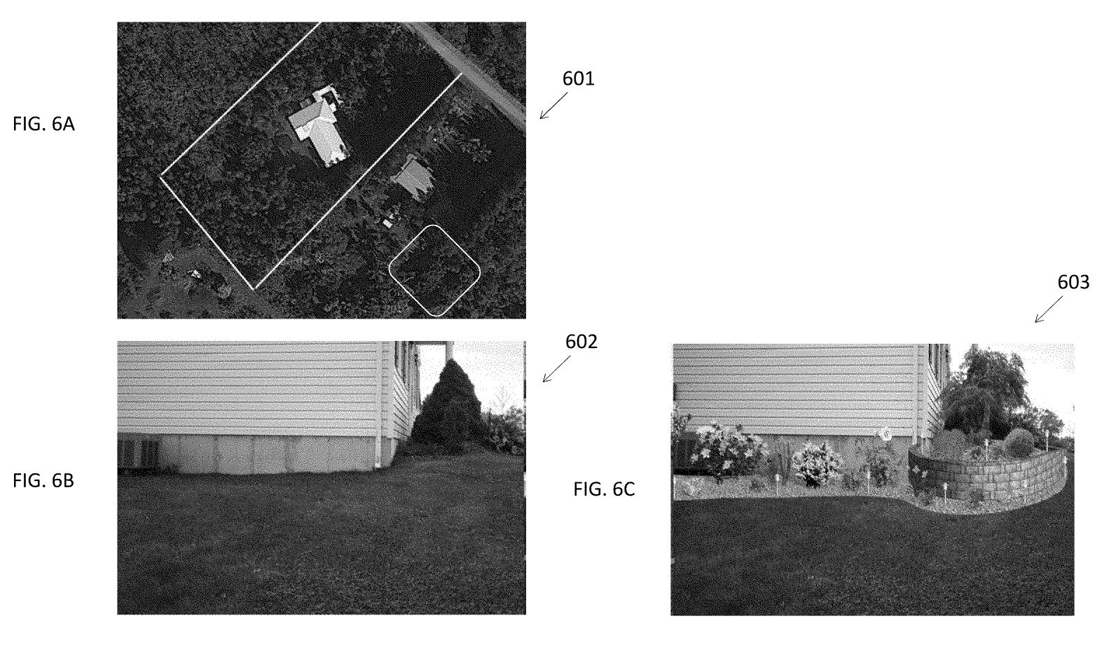

The display 36, e.g., a liquid crystal display or the like, is constructed and arranged for displaying a 2-D satellite image so that a user 11 can identify regions of the image for converting into a 3-D representation of a region of interest of the property displayed in the satellite image. FIGS. 6A and 6B illustrate a 2-D satellite image 601 and 3-D representation 602 of the satellite image, respectively, each of which may be displayed at the display 36. The display 36 can also display information regarding suggested item purchases, recommended landscape-regarding designs, simulations of a recommended landscape design (for example, shown in FIG. 6C), and so on. The user interface 38 may generate for display a time-of-day bar or the like, which identifies a location of the sun and an amount of shade at the selected region of the land property at a time of day. Data regarding the location or the sun, amount of shade, etc. may be processed by the landscape planning processor 20, which in turn can be used to establish the time-of-day bar, and wherein the recommended improvements take into account the location of the sun and an amount of shade at the selected region of the land property at the selected time of day.

The modification processor 40 receives from the second user device 34 data input by the customer 11 and/or the display 36 regarding customer-proposed modifications to the identified regions of the 2-D satellite image. For example, the customer 11 may select a region of interest from the displayed 2-D satellite image. The modification processor 40 can present options for the customer 11 to modify the selected open region of interest, for example, build a garden, fire pit, stone wall, and so on at the selected region of the displayed property. The presented options may be generated by the landscape planning processor 20, by analyzing the selected open region of interest and producing recommendations which are output as options to the modification processor 40.

The modification processor 40 can present a recommended option as a 3-D representation produced by and received from the landscape planning processor 20. For example, a 3-D representation may include a view of the property as provided in the 2-D satellite image, and overlaid with a realistic-looking replication of, shrubs, mulch, stones, patios, walls, fire pits, or the like identified in the user's desired or recommended property improvements by the landscape planning processor 20, for example, shown in the image 603 of FIG. 6C. The overlaid features may include dimensions, materials, shapes, and so on according to user input submitted via the second input device 34. The modification processor 40 may generate a recommended property improvement based on the user input and/or external data provided by the landscape planning processor 20. For example, a user may select a region of the property for adding a fire pit, along with dimensions of the fire pit. The modification processor 40 may produce a different simulation, for example, display the fire pit at a different location than the user's choice due to information received from an external source by the landscape planning processor 20 that there is a swamp, and therefore, mosquito beds, near the user's selected region of the property.

The processor interface 42 exchanges data with the landscape planning processor 20 and receives data such as recommendations, modifications, simulation data, or the like from the landscape planning processor 20, for example, illustrated in the previous example.

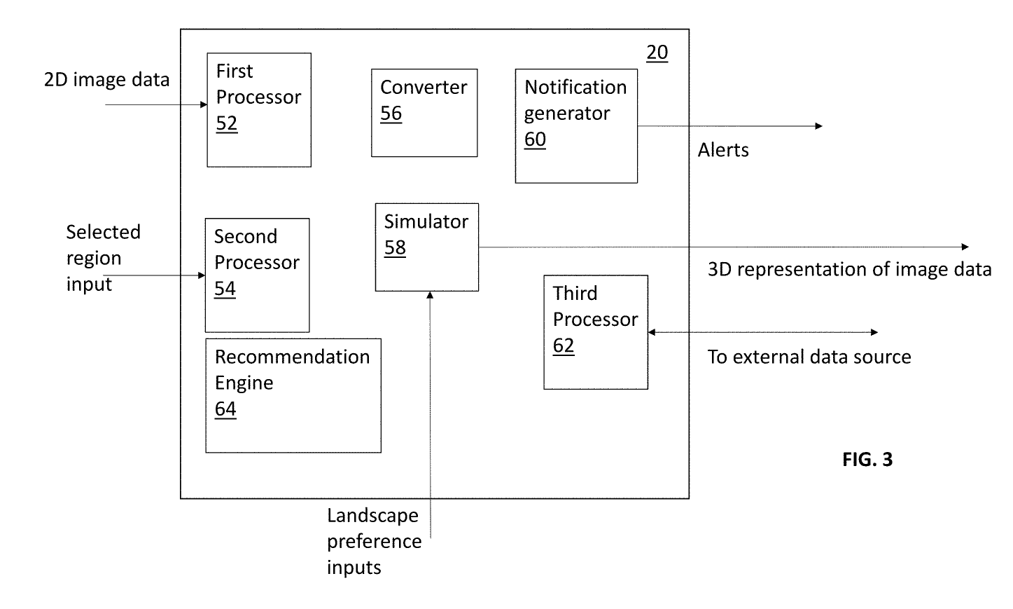

FIG. 3 is a block diagram of a landscape planning processor 20, in accordance with some embodiments. The landscape planning processor 20 may be part of the environment illustrated in FIG. 1.

The landscape processor 20 comprises a first processor 52, a second processor 54, a converter 56, a simulator 58, a notification generator 60, a third processor 62, and a recommendation engine 64. Although these components of the landscape processor 20 are shown as being part of a common hardware platform, some or all of first processor 52, second processor 54, converter 56, simulator 58, notification generator 60, third processor 62, and recommendation engine 64 can be at other hardware platforms, for example, at the kiosk 12.

The first processor 52 retrieves a two-dimensional image of a real property in response to a query by a user 11. The user 11 may submit a query to the kiosk 12 or mobile computing device 15 at the store 10 for a particular property, such as the user's home or other real property. Alternatively, the user 11 may submit a query at a remote location from the store 10, for example, at a user computer 14, or for a particular property, such as the user's home or other real property. A map, diagram, satellite image, and/or other 2-dimensional image of the requested real property may be electronically stored at the data repository 22.

The second processor 54 generates for display a two-dimensional view of a region of a real property of interest for simulation. For example, the user 11 may view at a kiosk or personal computer display screen a retrieved satellite image of a property of interest, and select a region of the satellite image for possible landscape improvements such as the addition of shrubbery, gardens, walkways, and so on, which is processed by the second processor 54 for display, for example, as an enlarged view relative to the original satellite image. The system may recognize certain features from the satellite image by image or object recognition techniques known to those of ordinary skill in the art. The viewer 11 may validate such identified features such as trees, ponds, driveways, and so on, for example, by providing input regarding improvements of interest to the landscape shown in the image.

The converter 56 converts the selected region of the displayed two-dimensional view into a three-dimensional image, which may replace or coexist with the two-dimensional view displayed on the display screen. The three-dimensional image generated may be based on depth assumptions provided by the customer 11 such as depth of a ditch, the slope of a hillside, the height of a tree, and so on. The converter 56 distinguishes from the modification processor 40 of the kiosk 12 in that the converter 56 performs a conversion function, while the modification processor 40 processes a converted file and overlays it with simulation details, as described above.

The simulator 58 updates the three-dimensional image of the real property according to recommended improvements to the real property, and outputs the result to the modification processor 40 of the kiosk 12. In particular, the simulator 58 places virtual plants, objects, and so on into a generated 3-D model. Here, the user 11 may view on a display screen what the user's selected property would look like if updated, for example, during various stages of a growing season based on predictive assumptions over time under specified conditions. Predictive assumptions may be received from external data sources, such as the Farmer's Almanac or other predictive sources. Specified conditions may likewise be received from external sources such as a data repository that stores historical weather data.

The notification generator 60 may output alerts to the user 11 regarding landscape-related actions the user 11 should take regarding an identified region of the property of interest, such as a garden that needs water based on predetermined rainfall. This data may be retrieved by the third processor 62 from an external data source, such as a weather-centric website, which includes data on type of soil, sunshine, humidity, and so on. Other alerts may pertain to when to fertilize, type of fertilizer, time of day to fertilize, etc. Other alerts may be on what insecticides to use, how to control insects, grubs based on time of year, how to keep animals from destroying plants, etc. Other alerts may be to alert the customer when to cover the plans, i.e., due to frost, hail, etc. Other alerts may be when to plant seeds, bulbs, digging up/transplants, etc. Other alerts may be when to trim hedges, mow law, etc.—weekly, etc. Here, the recommendation engine 64 can recommend tools for performing this function. Another notification may be remind the user 11 when they need certain products to keep garden healthy, or other care. The user 11 via a personal computing device can receive alerts to assist the user 11 with future gardening suggestions, inputs, and so on.

The third processor 62 retrieves data from a remote database that is used for generating simulation images and/or options for improving a selected region of property shown I in the images that are part of a simulation of the three-dimensional image of the user's property.

The recommendation engine 64 generates recommendations on selected regions of a 2-D image of a real property. The recommendation engine 64 may receive a combination of user inputs via the kiosk 12, such as types of plants, flowers, shrubs, selected by the user 11, and inputs received from external sources via the third processor 62, such as fertilization options, rainfall estimates at the address of the selected property, and so on. Also, the recommendation engine 64 may recognize and analyze certain items on the displayed 2-D image, such as trees or plants currently at the property that produce shade, type and/or acidity of soil, and so on. For example, the system 20 may determine a type of tree without recognizing the leaves on the tree by determining a height of the tree from shadows over time of day based on sun location which is captured by the images. The color of leaves may be determined in the fall, the time at which blooms are seen, a comparison of other known species, and so on.

A generated recommendation may include information regarding purchases made regarding the recommended improvements to the user's property. For example, the customer may have purchased a tree at the store. This information may be used to generate a recommendation to plant the tree at a particular region of the user's property based on soil conditions. Other recommendations may include suggested locations for placing stepping stones, gazebos, lawn furniture, and so on. Other recommendations may include specific product recommendations based on collected data, for example, particular weed killer products to use based on soil content, plant types, and so on.

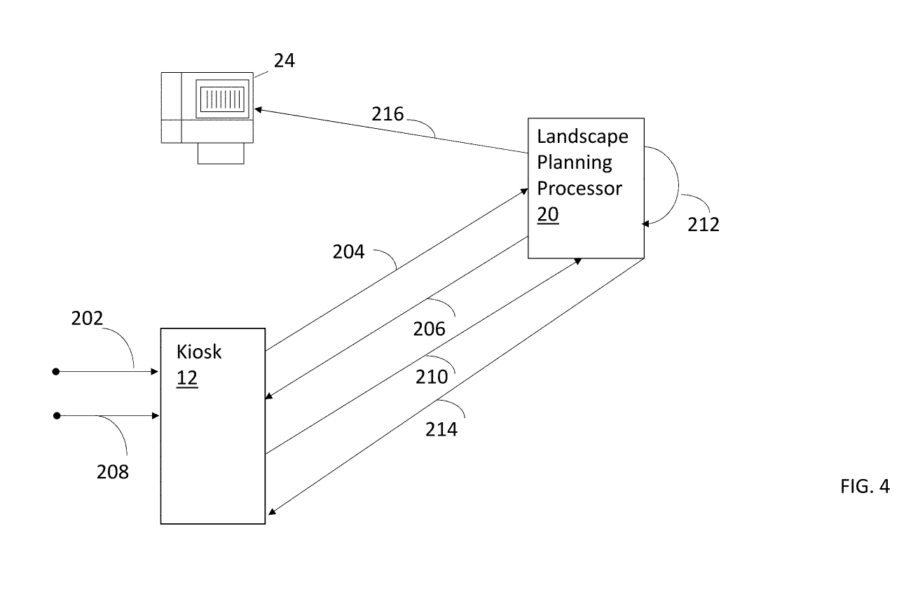

FIG. 4 is an illustration of flow paths between elements of the environment of FIG. 1, in accordance with some embodiment.

At step 202, a kiosk 12 receives a user input, namely, an address or other identifier of a real property of interest to a user 11 of the kiosk 12. The user 11 may be a store customer interested in improving a home or business by purchasing items and/or services used for gardening, landscaping, and so on.

At step 204, the kiosk 12 generates and outputs a request to the landscape planning processor 20 for an electronic image of the real property corresponding to the address or other identifier entered in step 202. Other data related to the address or other identifier may be included with or instead of the image data. The requested image data may include a satellite image, map, or other visual representation of the real property of interest.

At step 206, the landscape planning processor 20 provides a result, namely, a 2-D map or satellite image, of the real property identified in step 202. The landscape planning processor 20 may send a query to the data repository 22 and/or other remote repository where this data is known to be available.

At step 208, a user 11 may view on the kiosk display 36 the 2-D image and identify via the second input device 34, e.g., a touchscreen, mouse, keyboard, and so on a region of the 2-D image where the user 11 desires to perform a landscape-related function, such as gardening, building a stone wall, and so on. The user 11 may also input other information such as desired landscape projects, types of plants to grow, and so on.

At step 210, the kiosk 12 outputs the user input data provided in step 208 to the landscape planning processor 20, which at step 212 generates a 3-D image from the received user input data and 2-D image.

At step 214, the 3-D image if output from the landscape planning processor 20 to the kiosk 12 for display. This permits a gardener can walk through and see what the garden look like during various stages of the growing season based on predictive assumptions over time under specified conditions. In some embodiments, this may be achieved by the landscape planning processor 20 applying imaging time-lapse animation techniques or the like to a produced three-dimensional (3-D) video image.

At step 216, the 3-D image of the user's property picture overlaid with realistic-looking shrubs, mulch, stones, patios, walls, or the like identified in the user's desired or computer-recommended property improvements design is optionally generated by a 3-D printer 24 or the like, and/or displayed at the kiosk display 36.

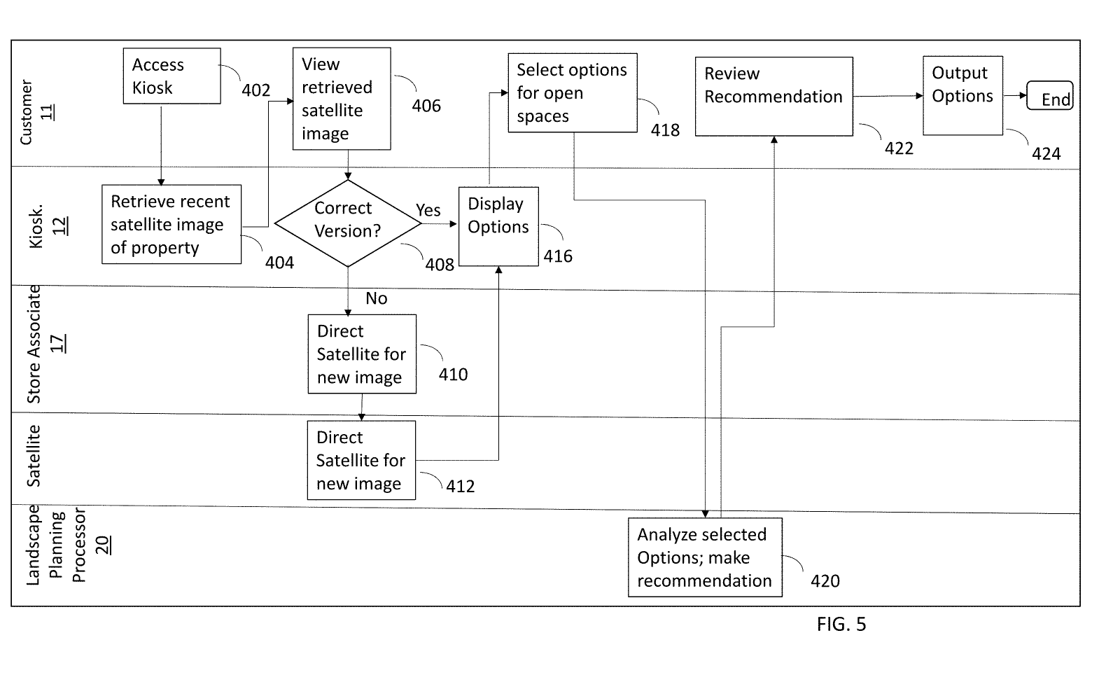

FIG. 5 is a flow diagram illustrating a landscape design process, in accordance with some embodiments. In describing the method, reference may be made of elements of FIGS. 1-4.

At block 402, a kiosk 12 is accessed by a user interested in landscape design, modification, and/or other related information.

At block 404, a satellite image is retrieved by the kiosk 12, for example, by the first processor 32 of the kiosk 12. A plurality of satellite images of the same property taken at different times may be stored. Thus, a most recent satellite may be retrieved.

At block 406 the user 11 may review the two-dimensional image displayed at the kiosk 12 or remote computer 26. The user 11 may determine whether the retrieved satellite image is a recent display, i.e., that it correctly captures the property of interest. For example, an older satellite image may not display recent property changes, such as an addition to the home, a new swimming pool, and so on.

At decision diamond 408, the kiosk 12 via the user interface 38 may present a request for the user to select whether the retrieved and displayed satellite image is a correct, i.e., most recent, version. If no, then the method proceed to block 410, where a store associate 17 or other authorized representative may direct a satellite to generate at least one new image of the property of interest. In other embodiments, the satellite images are retrieved from a third party database. The system may determine if the image of interest can be digitally aged, locate a later image than an image at hand, or request an updated image.

At block 412, the satellite generates the new images as directed. The new images may be stored at a data repository 22 or other remote data storage device. At block 416, options are presented at the kiosk 12 for possible improvements to the property identified in the image. The system may identify open or available regions of the property from the image that are candidates for improvement, and generate options for improving these areas.

Returning to decision diamond 408, if the kiosk 12 establishes that the images are recent images and acceptable for subsequent processing, then the method may proceed directly to block 416.

At block 418, the customer 11 may select options of the presented options at block 416 for open spaces of interest, where possible landscape modifications may be made. For example, a displayed 2-D image may illustrate an open space in a front lawn between the front door of the home shown on the property and the street. The open space may be surrounded by pine trees on the front lawn. The customer 11 may select from the kiosk 12 this displayed open space.

At block 420, the landscape planning processor 420 can analyze selected options and generate recommended items or services for performing the selected options. For example, the third processor 62 may retrieve information from a website regarding seasonal growing preferences at the location of the selected property. This data can be used to establish that orange trees are not appropriate for adding to the property, but apple trees are appropriate. In another example, the landscape planning processor 420 may establish from an image that the property includes pine trees, and establish from a remote source that the lawn is highly acidic due to the presence of pine trees, then recommend a particular type of grass conducive to an acidic soil.

At block 422, recommendations may be displayed at the kiosk 12 or remote computer display 26 for consideration by the shopper 12.

At block 424, a selected recommendation option may be output, for example, formed on a 3-D printer, and/or displayed at the kiosk 12 or remote computer display 26. A simulation result, for example, a simulation shown at FIG. 6C, may be provided to a remote computing device, such as a user's smartphone, which may permit the user to perform an augmented walkthrough of the property using the smartphone. A smartphone or other electronic device may also be used to communicate with the kiosk 12, for example, to retrieve and process relevant results produced at the kiosk 12.

In some embodiments, the system may be integrated with an online shopping site or the like, which provides an approach for ordering products, shipping, and payment methods.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A landscape design system, comprising:
a first processor for retrieving a two-dimensional image of a real property in response to a query by a user of the landscape design system;
a second processor that generates for display a two-dimensional view of a region of the real property for simulation;
a converter that converts a region of the two-dimensional view into a three-dimensional image in response to an identification of the region of the real property; and
a simulator that displays the three-dimensional image of the real property modified according to possible improvements to the real property.

2. The system of claim 1, further comprising a notification generator that generates and outputs alerts to an electronic device of the user regarding the simulated modified property.

3. The system of claim 1, wherein the first processor outputs a query to a remote database to receive the two-dimensional view of the property in response to a receipt by the processor of an address of the property.

4. The system of claim 1, wherein the two-dimensional view of the real property includes a satellite image.

5. The system of claim 1, further comprising a third processor for retrieving data from a remote database that is used for generating simulation images that are part of a simulation of the three-dimensional image of the user's property.

6. The system of claim 1, further comprising a recommendation engine that generates a recommendation for output to an electronic device.

7. The system of claim 6, wherein the recommendation includes information regarding purchased made regarding the recommended improvements to the user's property.

8. The system of claim 1, wherein the real property includes a property of the user of the landscape design system.

9. The system of claim 1, further comprising a user interface for providing interactive access for the user to modify the three-dimensional image of the real property.

10. The system of claim 1, wherein the three-dimensional image is derived exclusively from the two-dimensional view of the real property.

11. The system of claim 1, wherein the three-dimensional image is derived from a combination of the two-dimensional view of the real property and user input.

12. A kiosk for landscape design, comprising:
a first input device that receives a satellite image of a real property;
a second input device that receives user input;
a display for displaying the satellite image; and
a modification processor for permitting a user at one or more of the second user input and the display to simulation of a region identified in the satellite region, the simulation including a landscape modification, the display further for displaying a representation of the identified region and a result of a recommendation for the landscape modification.

13. The kiosk of claim 12, wherein the representation of the identified region includes three-dimensional image derived from a combination of the satellite image of the real property and the user input.

14. The system of claim 13, wherein the three-dimensional image is derived exclusively from a two-dimensional view of the satellite image of the real property.

15. A system for landscape design, comprising:
a kiosk, comprising:
an input device for receiving user inputs regarding a land property of a user; and
a network device for communicating with a central computer; and
the central computer, comprising
a first processor for retrieving a two-dimensional image of the land property in response to a query by the user at the kiosk;
a second processor that generates for display a two-dimensional view of a region of the land property for simulation;
a converter that converts a region of the two-dimensional view into a three-dimensional image in response to an identification of the region of the land property; and
a simulator that displays the three-dimensional image of the land property modified according to recommended improvements to the land property.

16. The system of claim 15, further comprising a 3-D printer for producing a physical representation of the modified three-dimension image.

17. The system of claim 15, wherein the three-dimensional image is derived exclusively from a two-dimensional view of a satellite image of the land property.

18. The system of claim 15, wherein the kiosk displays a time of day bar, which identifies a location of the sun and an amount of shade at the selected region of the land property at a time of day, and wherein the recommended improvements take into account the location of the sun and an amount of shade at the selected region of the land property at the selected time of day.

19. A method for landscape design, comprising:
receiving and processing by a special purpose hardware processor an electronic image of a real property;
identifying regions of the property of interest where a user desires to perform a landscape project; and
determining by a special purpose hardware processor recommendations to the regions of the property of interest.

20. The method of claim 19, further comprising generating an alert regarding the recommendations.
